(19) United States
(12) Patent Application Publication
(10) Pub. No.: US 2009/0135378 A1
(43) Pub. Date: May 28, 2009

(54) Projection Device

(75) Inventors: Chia-Jui Lin, Taoyuan Hsien (TW); Hui-Chih Lin, Taoyuan Hsien (TW); Hsiu-Ming Chang, Taoyuan Hsien (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: DELTA ELECTRONICS, INC., Taoyuan Hsien (TW)

(21) Appl. No.: 12/058,791

(22) Filed: Mar. 31, 2008

(30) Foreign Application Priority Data
Nov. 23, 2007 (TW) 096144521

(51) Int. Cl. G03B 21/16

(52) U.S. Cl. 353/61

(57) ABSTRACT

A projection device is provided. The projection device comprises a heat source, a housing, and a cooling system. The cooling system is disposed inside the housing of the projection device. The housing comprises at least one outlet and at least one inlet. The cooling system comprises a first cooling device and a second cooling device, wherein the first cooling device is adapted to guide the air outside the housing from the inlet to the outlet, while the second cooling device is disposed adjacent to the outlet and inhales the air outside the housing through the outlet to cooperatively dissipate the heat generated by the heat source of the projection device.

This application claims priority to Taiwan Patent Application No. 096144521 filed on Nov. 23, 2007; the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention provides a projection device with reduced noise, increased cooling efficiency and a miniaturized profile.

2. Descriptions of the Related Art

Centrifugal fans have been used to provide an efficient cooling system in conventional projection devices. The centrifugal fans, which deliver high static air pressure, need to be used in conjunction with a certain number of axial flow fans so that the waste heat generated from inside the projection device can be dissipated effectively. However, to install such a centrifugal fan within a restricted space, either the volume of the projection devices need to be increased accordingly or the number of axial flow fans need to be reduced.

FIG. 1 illustrates the internal arrangement of a conventional projection device 1. The projection device 1 comprises a light source 11, a housing 12, an axial flow fan 13, a centrifugal fan 14, an optical system 15 and a power supply 16. The housing 12, inside which the light source 11 is disposed, comprises an air outlet 121 and two air inlets 122. The axial flow fans 13 and the centrifugal fan 14 guide the colder air from the exterior of the housing 12 through the light source 11 using the two air inlets 122 before the air exits the outlet 121. It should be noted that the air flow fields are schematically indicated in the figures with dashed arrows. The centrifugal fan 14 further has an air conduit 141 for guiding the air from the outside towards the light source 11 to effectively dissipate the high heat generated by the light source 11.

In conventional projection devices, the optical system 15 and the power supply 16 are arranged inside the housing 12, while the centrifugal fan 14 is installed next to the axial flow fan 13 due to the limited leftover space. However, to accommodate the additional centrifugal fan 14 without changing the arrangements of other components, a portion of the remaining space that was originally reserved for the two axial flow fans 13 is occupied by the centrifugal fan 14, leading to insufficient space to house more than one axial flow fan 13. In this case, the only way to maintain sufficient cooling air flow is to increase the rotational speed of the axial flow fan 13 to effectively dissipate the heat of the projection device 1. Unfortunately, this will exacerbate the noise generated by the axial flow fan 13, thus deteriorating the operation quality of the projection device 1.

FIG. 2 illustrates another internal arrangement of the conventional projection device 1. Unlike the previous embodiment, the centrifugal fan 14 in this embodiment is installed between the optical system 15 and the housing 12. However, such an arrangement requires the displacement of a portion of the optical system 15 that had originally been located there, and as a consequence, only a single axial flow fan 13 can fit in the projection device 1. Likewise, to supply sufficient cooling air flow, the rotational speed of the axial flow fan 13 has to be increased, thus leading to exacerbated noise generated from the axial flow fan 13.

FIG. 3A illustrates yet another internal arrangement of the projection device 1. To install two axial flow fans 13 in the projection device 1, the centrifugal fan 14 is installed at the bottom of the optical system 15 in this arrangement. The side view of the third internal arrangement is depicted in FIG. 3B. In this case, because the centrifugal fan 14 is installed at the bottom of the other elements inside the projection device 1, the overall thickness of the projection device 1, thereby increasing the volume of the projection device 1, making the projection device bulkier.

Accordingly, it is important to provide a solution that allows the appropriate arrangement of the axial flow fans and the centrifugal fan within the restricted space of an existing projection device to improve the cooling efficiency of the cooling system with reduced fan noise and without increasing the volume of the projection device.

### SUMMARY OF THE INVENTION

One objective of this invention is to provide a projection device with a cooling system that is arranged to provide adequate cooling capability within a restricted space. The projection device comprises a first heat source, a housing, and a cooling system. The housing comprises at least one inlet and at least one outlet, and receives the first heat source and the cooling system therein. The cooling system comprises a first cooling device and a second cooling device. The first cooling device is adapted to guide the air from outside the housing to the at least one inlet and towards the at least one outlet, while the second cooling device, which is disposed adjacent to the at least one outlet for saving space, inhales the air from outside the housing and guides the air through the at least one outlet to dissipate the heat generated by the first heat source.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates the first internal arrangement of a conventional projection device;

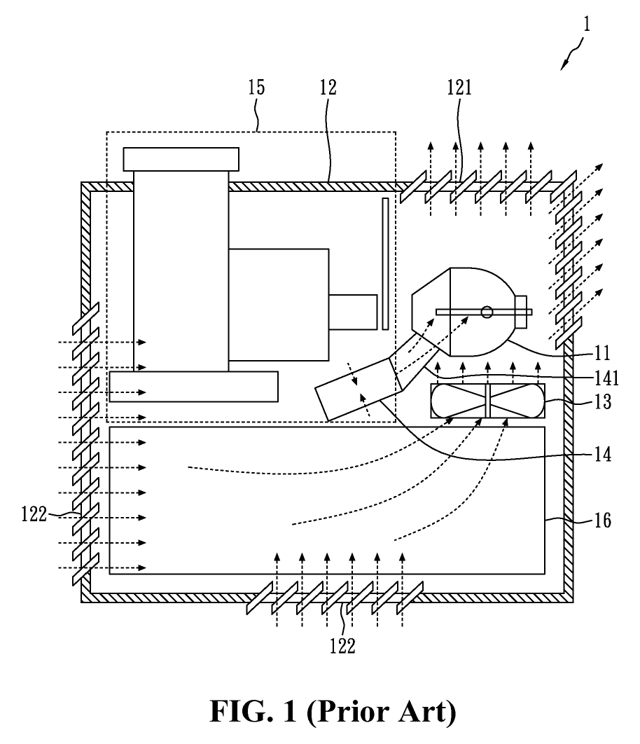

FIG. 2 illustrates the second internal arrangement of a conventional projection device;

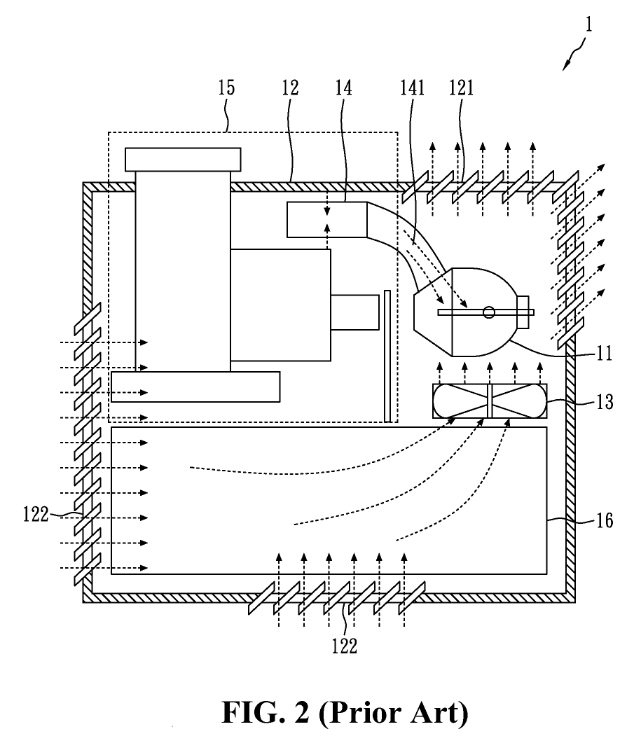

FIG. 3A illustrates the third internal arrangement of a conventional projection device;

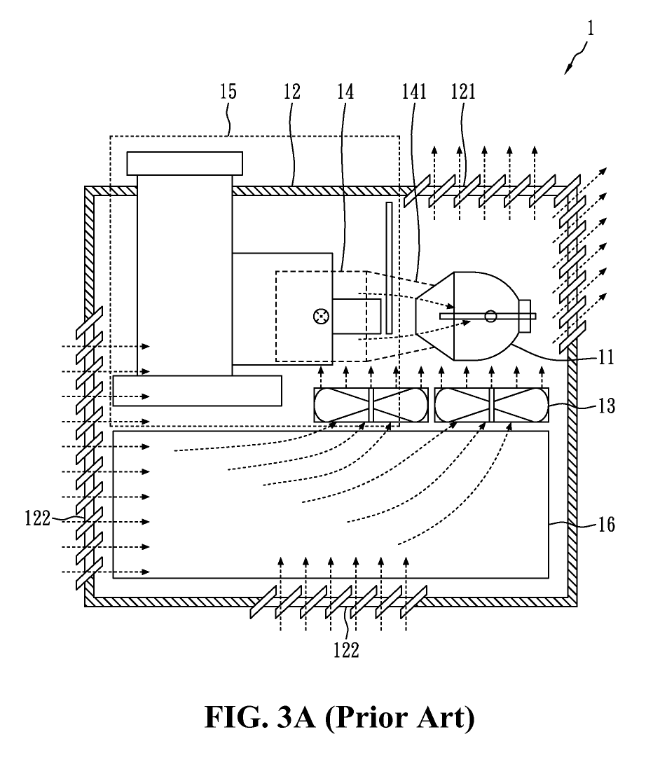

FIG. 3B illustrates a side view of the third internal arrangement of the projection device shown in FIG. 3A;

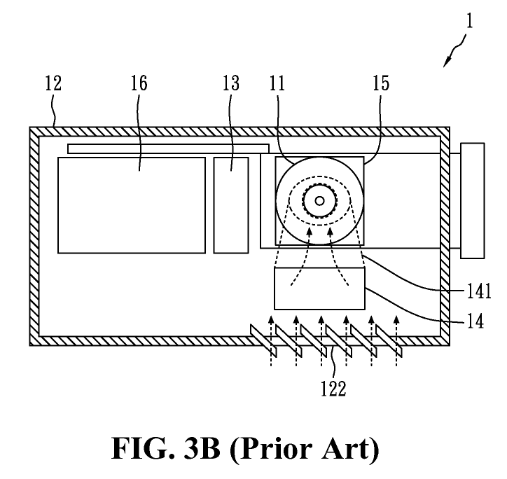

FIG. 4 illustrates the internal arrangement of an embodiment of the projection device in accordance with this invention; and

FIG. 5 illustrates a perspective view of the internal arrangement of an embodiment of a projection device in accordance with this invention.

### DESCRIPTION OF THE PREFERRED EMBODIMENT

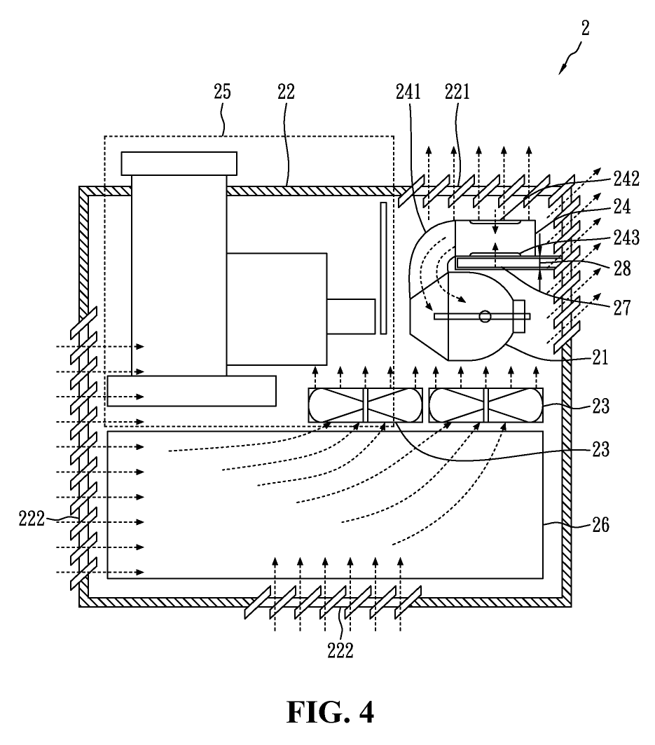

As shown in FIG. 4, a projection device 2 in accordance with the embodiment of this invention comprises a first heat source, a second heat source and a cooling system. In this embodiment, the first heat source is a light source 21 and/or an optical system 25, while the second heat source consists of a plurality of electronic components including a power supply 26. The light source 21 is disposed inside the housing 22 of the projection device 2. In a real embodiment, the light source 21 may be an ultra high pressure (UHP) lamp. When the light source 21 is emitting light, high heat and a high temperature ranging from 250° C. to 400° C. can be expected around the light source 21 inside the housing 22. In this embodiment, the housing 22 comprises an outlet 221 and two inlets 222. However, it should be noted that the number and arrangement of the outlet 221 and the inlets 222 described herein are only provided for illustration rather than to limit the scope of this invention. In a real embodiment, this invention may work with housings of various profiles and various arrangements of inlets and outlets, which will be described in detail later.

The cooling system of the projection device 2 comprises a first cooling device 23 and a second cooling device 24. In this embodiment, the first cooling device 23 is arranged between the first heat source (e.g., the light source 21 and/or the optical system 25) and the second heat source (a plurality of electronic components such as the power supply 26) inside the housing 22, and is adapted to guide cool air outside the housing 22 from the two inlets 222 towards the outlet 221 to cool the first and the second heat sources inside the housing 22 uniformly. In this figure, the guiding action of the first cooling device 23 is schematically indicated by the arrows. On the other hand, one of the features of this invention is that the second cooling device 24 is arranged inside the housing 22 adjacent to the outlet 221 so that air at a lower temperature about 40° C. to 60° C. is inhaled from outside the housing 22 through the outlet 221 to cooperatively dissipate the high heat generated by the light source 21.

Compared with the conventional projection devices, the second cooling device 24 in this invention is arranged inside the housing 22 adjacent to the outlet 221, so that a larger space inside the projection device 2 will be available for the first cooling device 23. In this embodiment, the first cooling device 23 has two axial flow fans arranged side by side in the remaining space of the housing 22 after the optical system 25 and the power supply 26 are installed, and is disposed opposite to the second cooling device 24 with respect to the light source 21 to provide the projection device 2 with adequate cooling capability.

In this embodiment, the second cooling device 24 comprises a centrifugal fan, for example, a blower. As described above, to provide more space available for the first cooling device 23, the blower in this embodiment is disposed adjacent to the outlet 221 and inhales air outside the housing 22 through the outlet 221. Then, the air is blown towards the light source 21 through an air conduit 241 connected to the blower to cooperatively dissipate the high heat generated by the light source 21. Although the temperature (about 40° C. to 60° C.) of the air inhaled through the outlet 221 is generally higher than that of the air (at room temperature) inhaled through the inlets 222, the air is still substantially much lower than the temperature around the light source 21 and therefore suffices as a cooling air source.

Additionally, the second cooling device 24 further comprises a partition 27 for the following reasons. Since the second cooling device 24 is arranged beside the light source 21 between the light source 21 and the outlet 221, and the air guided by the first cooling device 23 passes through, one sidewall of the second cooling device 24 adjacent to the light source 21 is exposed to a considerably high temperature. If the temperature substantially exceeds the upper operation temperature limit of the second cooling device 24, the second cooling device 24 will be damaged severely. In addition, the heat generated inside the entire projection device 2 will prevent effective dissipation and cooling, thus putting the projection device 2 in risk of damage. In view of this, a partition 27 is arranged on the sidewall of the second cooling device 24 adjacent to the light source 21 to isolate the second cooling device 24 from the high heat generated by the light source 21. Further in this embodiment, the partition 27 and the sidewall of the second cooling device 24 are formed with an interval 28 therebetween, which may be filled with air to significantly isolate the second cooling device 24 from the high heat generated by the light source 21. However, as is well-known to those of ordinary skill in the art that any technical means for substantially isolating high heat can be used for the second cooling device 24 of this invention. For example, other cooling materials may also be filled into this interval 28. The interval 28 may also be deflated to a vacuum status for heat isolation, or the like.

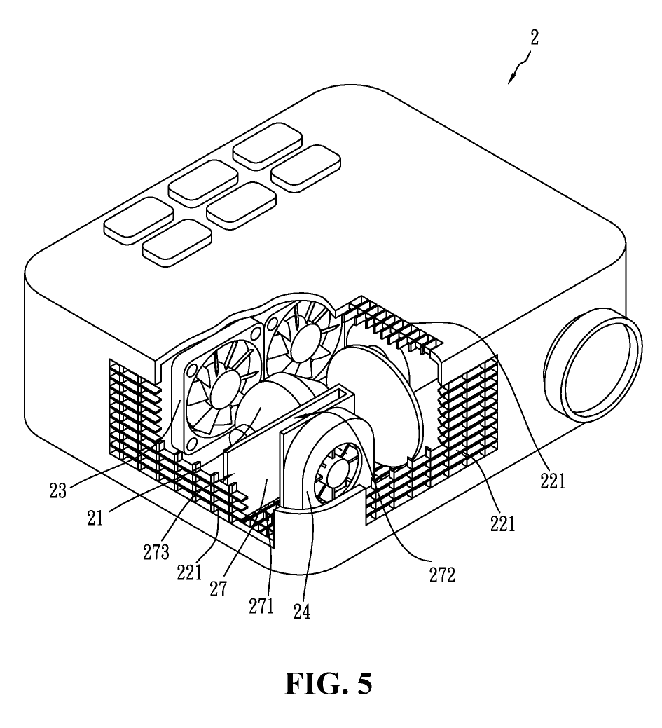

As shown in both FIGS. 4 and 5, the partition 27 in this embodiment has a bottom opening 271, a top opening 272 and a side opening 273. In other embodiments, the partition 27 may have any combination of one or two (not shown) of the bottom opening 271, the top opening 272 and the side opening 273 depending on actual structure of the projection device 2. A shutter structure shown at the lower left corner in FIG. 5 functions as the outlet 221, while the bottom opening 271 of the partition 27 opens towards the shutter structure of the outlet 221 at the bottom of the housing 22. Because the partition 27 is provided by the bottom opening 271, the top opening 272 or the side opening 273, fluid connection is established between the interval 28 and the outlet 221 to cause convection between the air in the interval 28 and the air outside the housing 22, thus enhancing the heat isolation effect for the second cooling device 24.

In a real embodiment, the centrifugal fan of the second cooling device 24 may either be a single-entrance blower with a single air entrance or a dual-entrance blower with two air entrances. In more detail, in the case of a single-entrance blower, the centrifugal fan comprises only a first air entrance 242, which is disposed immediately adjacent to the outlet 221 to inhale the air from outside the housing 22. In the interval 28 on the other side of the centrifugal fan, a convection layer in fluid connection with the atmosphere is formed to isolate the centrifugal fan against any adverse effect of the heat generated by the light source 21. In other examples, in case the partition 27 is not formed with such openings, a static air layer will be formed in the interval 28. An actual experimental test reveals that such a static air layer still acts to effectively isolate most of the heat generated by the light source 21 and therefore ensures normal operation of the centrifugal fan.

In the case of a dual-entrance blower, the centrifugal fan further comprises a second air entrance 243, which is disposed on the inner edge of the sidewall opposite to the first air entrance 242. As a result, fluid connection is established between the second air entrance 243 of the centrifugal fan and the interval 28, so that the centrifugal fan is allowed to inhale the cool air outside the housing 22 through the interval 28 and the first air entrance 242 simultaneously. In this way, the cool air continuously brought into the interval 28 will serve to isolate the centrifugal fan from heat generated by the light source 21. On the other hand, the cool air coming through the interval 28 and the first air entrance 242 simultaneously will further improve the cooling efficiency of the centrifugal fan to cool the first heat source (the light source 21 and/or the optical system 25).

In summary, by disposing a cooling fan adjacent to the outlet 221 in the projection device of this invention, the otherwise restricted space available inside the projection device is enlarged to allow the arrangement of more cooling fans, and thus the cooling efficiency of the projection device is increased. In this way, shortcomings of the conventional projection devices, which can only provide a limited number of fans at the cost of increased rotational fan speed and consequent exacerbated noise, are alleviated. Furthermore, this invention can provide a cooling system with low noise and high cooling efficiency, thereby improving the operation quality of the projection device.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A projection device, comprising:
a first heat source;
a housing, receiving the first heat source, and comprising at least one inlet and at least one outlet; and
a cooling system, disposed in the housing, the cooling system comprising:
a first cooling device adapted to guide the air outside the housing from the at least one inlet toward the at least one outlet; and
a second cooling device, being adjacent to the at least one outlet, and adapted to inhale the air outside the housing through the at least one outlet to cooperatively dissipate heat generated by the first heat source.

2. The projection device as claimed in claim 1, wherein the second cooling device comprises a blower and a partition, which is disposed between the blower and the first heat source for isolating the blower from heat generated by the first heat source.

3. The projection device as claimed in claim 2, wherein the blower has at least one air entrance and a sidewall, the air entrance is adapted to inhale the air outside the housing through the at least one outlet, and the partition is disposed on the sidewall to form an interval with the sidewall.

4. The projection device as claimed in claim 3, wherein the partition has a bottom opening to make the interval being in fluid connection with the at least one outlet so that part of the air is adapted to be retained within the interval.

5. The projection device as claimed in claim 3, wherein the partition has a top opening to make the interval being in fluid connection with the at least one outlet so that part of the air is adapted to be retained within the interval.

6. The projection device as claimed in claim 3, wherein the partition has a bottom opening and a top opening to make the interval being in fluid connection with the at least one outlet so that part of the air is adapted to be retained within the interval.

7. The projection device as claimed in claim 3, wherein the partition further has a side opening to make the interval being in fluid connection with the at least one outlet.

8. The projection device as claimed in claim 4, wherein the partition further has a side opening to make the interval being in fluid connection with the at least one outlet.

9. The projection device as claimed in claim 5, wherein the partition further has a side opening to make the interval being in fluid connection with the at least one outlet.

10. The projection device as claimed in claim 6, wherein the partition further has a side opening to make the interval being in fluid connection with the at least one outlet.

11. The projection device as claimed in claim 2, wherein the blower has a first air entrance, a second air entrance and a sidewall, the first air entrance is adapted to inhale the air outside the housing through the at least one outlet, the second air entrance is disposed at an inner edge of the sidewall opposite to the first air entrance, the partition is disposed on the sidewall to form an interval with the sidewall, and the interval being in fluid connection with the second air entrance.

12. The projection device as claimed in claim 11, wherein the partition has a bottom opening being in fluid connection with the at least one outlet so that the second air entrance is adapted to inhale the air outside the housing through the interval.

13. The projection device as claimed in claim 11, wherein the partition has a top opening being in fluid connection with the at least one outlet so that the second air entrance is adapted to inhale the air outside the housing through the interval.

14. The projection device as claimed in claim 11, wherein the partition has a bottom opening and a top opening both being in fluid connection with the at least one outlet so that the second air entrance is adapted to inhale the air outside the housing through the interval.

15. The projection device as claimed in claim 11, wherein the partition further has a side opening being in fluid connection with the at least one outlet so that the second air entrance is adapted to inhale the air outside the housing through the interval.

16. The projection device as claimed in claim 12, wherein the partition further has a side opening being in fluid connection with the at least one outlet so that the second air entrance is adapted to inhale the air outside the housing through the interval.

17. The projection device as claimed in claim 13, wherein the partition further has a side opening being in fluid connection with the at least one outlet so that the second air entrance is adapted to inhale the air outside the housing through the interval.

18. The projection device as claimed in claim 14, wherein the partition further has a side opening being in fluid connection with the at least one outlet so that the second air entrance is adapted to inhale the air outside the housing through the interval.

19. The projection device as claimed in claim 2, wherein the blower is a centrifugal fan.

20. The projection device as claimed in claim 19, wherein the first cooling device comprises at least one axial flow fan disposed opposite to the blower with respect to the first heat source.

21. The projection device as claimed in claim 20, wherein the first cooling device comprises two axial flow fans arranged side by side.

22. The projection device as claimed in claim 1, wherein the first heat source is a light source.

23. The projection device as claimed in claim 1, further comprising a second heat source which includes a plurality of electronic devices, and the first cooling device is disposed between the first heat source and the second heat source to guide the air outside the housing from the at least one inlet to pass through the first heat source and the second heat source and then to be exhaled out of the at least one outlet.
